(19) United States
(12) Patent Application Publication
(10) Pub. No.: US 2016/0156425 A1
(43) Pub. Date: Jun. 2, 2016

(54) WIRELESS COMMUNICATION SYSTEM, CONTROL APPARATUS, OPTIMIZATION METHOD, WIRELESS COMMUNICATION APPARATUS AND PROGRAM

(71) Applicant: International Business Machines Corporation, ARMONK, NY (US)

(72) Inventors: Yasunao Katayama, TOKYO (JP); Yasuteru Kohda, Kanagawa-ken (JP); Daiju Nakano, Kanagawa-ken (JP); Kohji Takano, TOKYO (JP)

(21) Appl. No.: 14/947,032

(22) Filed: Nov. 20, 2015

(30) Foreign Application Priority Data
Nov. 27, 2014 (JP) 2014-239541

(51) Int. Cl. H04B 17/345; H04W 24/02

(52) U.S. Cl. CPC H04B 17/345; H04W 24/02

(57) ABSTRACT

Wireless communication system, control apparatus, optimization method, wireless communication apparatus and program for optimizing a beam configuration of an area that is configured by dividing a wireless communication network. The wireless system includes a control apparatus and multiple wireless links which are arranged in an area where the control apparatus is in charge of optimizing a beam configuration. The control apparatus includes: a section for setting an antenna parameter for multiple wireless links in the area the control apparatus is in charge of, in accordance with a search algorithm; and section for evaluating the antenna parameter set by the setting section on the basis of radiation of electromagnetic waves.

### CROSS-REFERENCE TO RELATED APPLICATION

This application claims the benefit of priority to Japanese Patent Application No. 2014-239541, filed Nov. 27, 2014, the contents of which are incorporated herein by reference.

### BACKGROUND

The present invention relates to wireless communication technique for optimizing a beam configuration in a wireless communication network.

In order to realize high-speed wireless communication at a data rate exceeding Gbps, hopes have been placed on a wide-band wireless communication technique using a carrier of a millimeter wave band. In the wireless communication field, communication bandwidth has been conventionally improved by utilizing a CDM (Code Division Multiplexing) technique and a new frequency band. In the millimeter wave band however, only a small number of channels can be assigned to high-speed communication, and frequency resources are restricted. From such a background, there has been a demand for improving bandwidth by SDM (Spatial Division Multiplexing).

In the millimeter wave wireless communication described above, a beam forming technique can be applied by using an array antenna. Further, as a method for optimizing parameters such as gains and phases of antenna elements of an array antenna, a technique utilizing PSO (Particle Swarm Optimization) is known. In the conventional technique described above, space is assumed as shared-media, which is used in Ethernet®. Therefore, in a system where communications through multiple wireless links are established not by time division but by space division with the same frequency, there is a possibility that convergence does not occur even if optimization is repeatedly performed and a possibility that, even if convergence occurs, optimization is not performed with a sufficient accuracy. This is because influence of interference noise by side lobes of radiation patterns of other wireless links is not taken account of. With regard to a space division multiplex technique, JP2011-199831A discloses a technique for eliminating interference between users generated in a receiving apparatus in a downlink of MU (Multi User)-MIMO (Multi-Input Multi-Output). The conventional technique described above is, however, a technique for performing communication from a single base station to multiple user terminals at the same time and cannot be applied to an independent wireless link such as a peer-to-peer wireless link. Therefore, there has been a demand for development of a technique making it possible to, in a wireless communication network where multiple independent wireless links exist, and communications of the multiple wireless links are established by space division with the same frequency, efficiently optimize a beam configuration for space as a whole while taking account of influence of interference among the wireless links.

### SUMMARY

In one aspect of the present invention, there is provided a wireless communication system including: a control apparatus and multiple wireless links which are arranged in an area where the control apparatus is in charge of optimizing a beam configuration and each of which is independently communicable. The control apparatus includes: a setting section for setting an antenna parameter set for the multiple wireless links in the area the control apparatus is in charge of, in accordance with a search algorithm; and an evaluating section for evaluating the antenna parameter set set by the setting section, on the basis of radiation of electromagnetic waves in each of the multiple wireless links in the area the control apparatus is in charge of, in a state that interference electromagnetic waves from at least one wireless link arranged in an adjoining area adjoining the area the control apparatus is in charge of are generated.

In another aspect of the present invention, there is an optimization method executed by a control apparatus in charge of optimizing a beam configuration of an area that is configured by dividing a wireless communication network and that includes multiple wireless links each of which is independently communicable. The method includes: setting an antenna parameter set for the multiple wireless links in the area the control apparatus is in charge of, in accordance with a search algorithm; and evaluating the antenna parameter set by the setting step, on the basis of radiation of electromagnetic waves in each of the multiple wireless links in the area the control apparatus is in charge of, in a state that interference electromagnetic waves from at least one wireless links arranged in an adjoining area adjoining the area the control apparatus is in charge of are generated.

In another aspect of the present invention there is a non-transitory computer readable storage medium tangibly embodying a computer readable program code having computer readable instructions which, when implemented, cause a computer device to carry out the steps of a method for optimizing a beam configuration of an area that is configured by dividing a wireless communication network and that includes multiple wireless links each of which is independently communicable. The method includes: setting an antenna parameter set for the multiple wireless links in the area the control apparatus is in charge of, in accordance with a search algorithm; and evaluating the antenna parameter set by the setting section, on the basis of radiation of electromagnetic waves in each of the multiple wireless links in the area the control apparatus is in charge of, in a state that interference electromagnetic waves from at least one wireless links arranged in an adjoining area adjoining the area the control apparatus is in charge of are generated.

### BRIEF DESCRIPTION OF THE SEVERAL VIEWS OF THE DRAWINGS

FIG. 1 is a diagram illustrating a network environment targeted by an optimization process in an embodiment of the present invention;

FIG. 2 is a diagram illustrating beam forming of a conventional technique;

FIG. 3 is a diagram outlining the optimization process according to the embodiment of the present invention;

FIG. 4 is a hardware configuration diagram of nodes in a wireless communication system according to the embodiment of the present invention;

FIG. 5 is a diagram illustrating a control plane connecting nodes in the network environment according to the embodiment of the present invention;

FIG. 6 is a functional block diagram of the wireless communication system according to the embodiment of the present invention;

FIG. 7 is a diagram illustrating interference electromagnetic waves generated from an adjoining area to an optimization area in the wireless communication system according to the present embodiment, and a method for determining evaluation time;

FIG. 8 is a flowchart showing the optimization process executed by a control node according to the embodiment of the present invention;

FIG. 9 is a receiving-side circuit configuration diagram of a node constituting a wireless link in a preferred embodiment;

FIG. 10 is a diagram illustrating a packet that a receiving-side node in an adjoining area receives;

FIG. 11 is a diagram illustrating how to use an evaluation function in a preferred embodiment; and

FIG. 12 is a diagram showing an application example of a wireless communication system to which the optimization method according to the present invention can be applied.

### DETAILED DESCRIPTION

The present invention will be described below with a particular embodiment. The present invention, however, is not limited to the embodiment described below. In the embodiment described below, as examples of a control apparatus and a wireless communication system, a control node that executes a beam configuration optimization process and a wireless communication system that includes the control node and at least one nodes will be described, respectively.

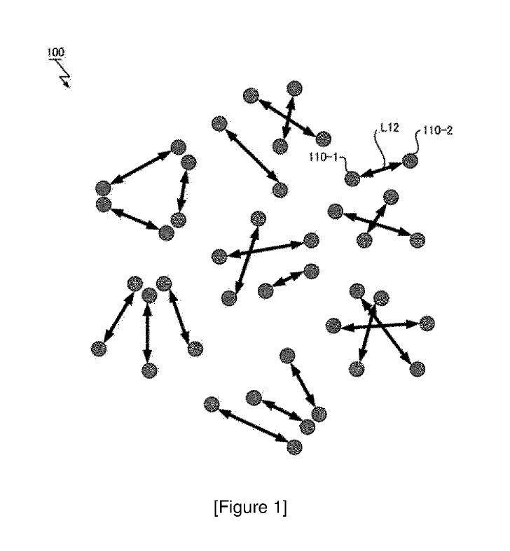

First, the characteristics of a network environment, which is a wireless communication network targeted by the beam configuration optimization process according to the embodiment of the present invention, will be described with reference to FIG. 1. FIG. 1 is a diagram illustrating the network environment targeted by the optimization process in the embodiment of the present invention.

In network environment 100 shown in FIG. 1, there exist multiple nodes 110 each of which has a wireless communication function. Each of the nodes 110 is provided with an array antenna, such as a phased array antenna, and is configured such that it can establish a wireless link L with node 110 to be its communication counterpart by beam forming. In FIG. 1, two nodes are representatively given reference numerals 110-1 and 110-2, and each circle in FIG. 1 indicates a node. Further, a wireless link between node 110-1 and node 110-2 is representatively given reference numeral L12, and each arrow in FIG. 1 indicates a wireless link L established between nodes 110.

As shown in FIG. 1, multiple peer-to-peer wireless links L are configured which are independently communicable and in which nodes 110 communicate directly with each other not via an access point, as shown in FIG. 1. In a particular embodiment, each wireless link L is a link that performs wireless communication using a millimeter wave band carrier. In the millimeter wave band, however, frequency resources available for establishing multiple wireless links are limited. Further, although time division can be used to establish multiple wireless links with the same frequency, the bandwidth of each wireless link is reduced in that case. Therefore, in order to realize further improvement of communication bandwidth using the limited frequency resources, it is necessary to establish multiple wireless links by space division with the same frequency and improve space efficiency.

The object of the optimization process according to the embodiment of the present invention is to, in network environment 100 as shown in FIG. 1, establish multiple independently communicable wireless links by space division with the same frequency as well as optimize the whole beam configuration so that high communication quality can be obtained.

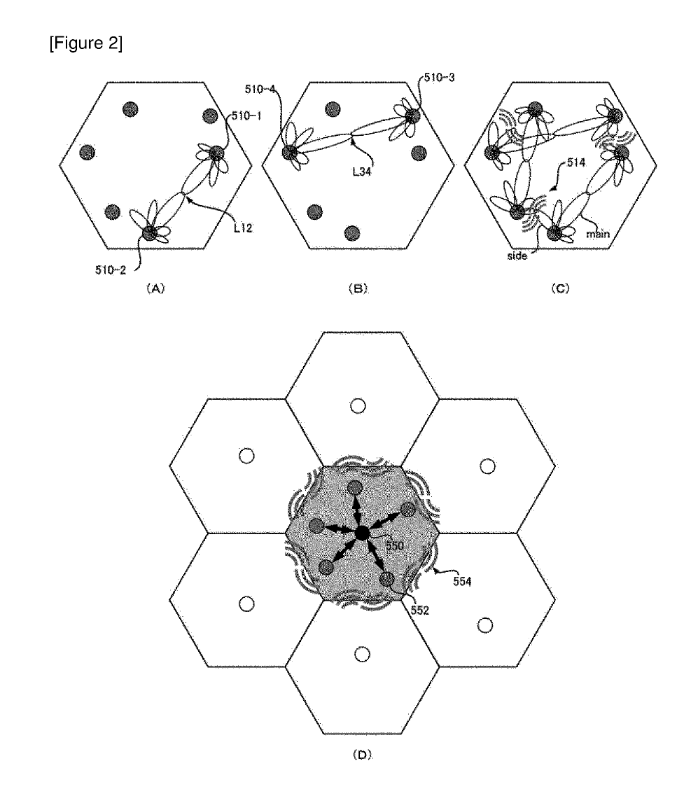

First, optimization of beam forming in a conventional technique will be described with reference to FIG. 2. FIG. 2 is a diagram illustrating the beam forming of the conventional technique. In the beam forming prescribed in IEEE802.15.3c and IEEE802.11ad, which has been described above, it is assumed that time division is performed among nodes, that is, the number of electromagnetic waves with the same frequency existing in space at the same time is only one. On this assumption, it can be said that beam forming optimization only has to be performed for each wireless link, such as optimizing a wireless link L12 between nodes 510-1 and 510-2 first, then optimizing a wireless link L34 between nodes 510-3 and 510-4, and so on as shown in FIGS. 2(A) and 2(B).

In the case of attempting to simultaneously establish communications of multiple wireless links with the same frequency, however, it is difficult to perform optimization by the conventional technique described above. As shown in FIG. 2(C), a radiation pattern includes a main lobe (main) and side lobes (sides). When time division is not performed, there is a possibility that wireless links mutually generate interference electromagnetic waves 514 due to influence of the side lobes. Therefore, even if optimization is repeatedly performed for each wireless link, there is a possibility that convergence does not occur. Even if convergence occurs, there is a possibility that sufficient accuracy cannot be obtained because the interference electromagnetic waves are not taken account of.

In addition, MIMO as shown in FIG. 2(D) is also known as a technique for establishing communications of multiple wireless links by space division with the same frequency. In the MIMO, optimization is generally performed independently for each area, with access point 550 as the center. However, since interference electromagnetic waves 554 among areas are generated, countermeasures such as frequency division are required. Further, in MU-MIMO, it can be said that multiple wireless link exist in an area. However, simultaneous communications are performed only through downlinks from access point 550, which is the center, to multiple clients 552, and the MU-MIMO cannot be applied to independent peer-to-peer wireless links. Cooperative MIMO is also known. However, a single controller that controls multiple access points causes the multiple access points to operate in synchronization with one another, and the cooperative MIMO cannot be applied to multiple independent wireless links.

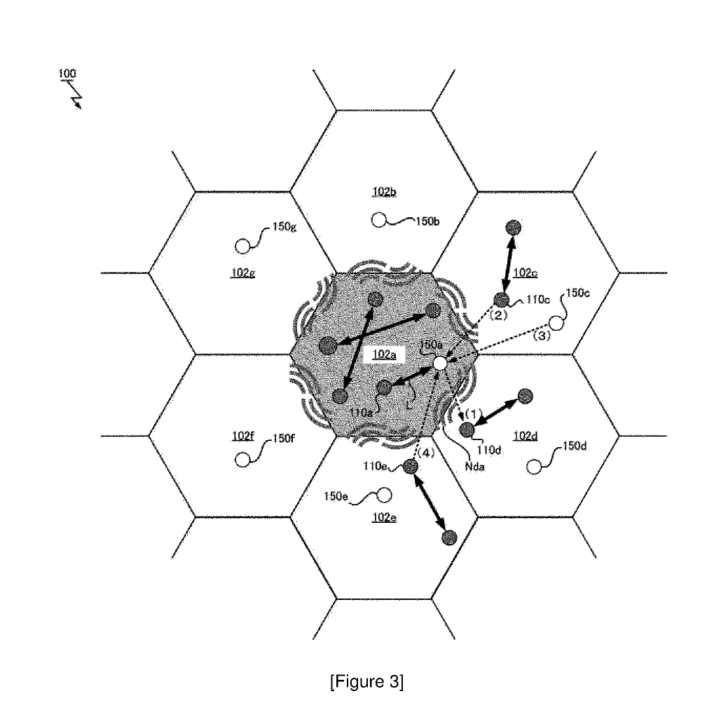

Therefore, in network environment 100 described above, it is necessary to improve beam intensity in each wireless link while reducing influence of interference among wireless links and, thereby, optimize the beam configuration of the whole network environment 100. On the other hand, in the case of simultaneously performing optimization for all wireless links in network environment 100, the number of nodes is too large, and convergence itself requires much time. Further, it is necessary to collect evaluation results of the wireless links to one node. Therefore, the control plane becomes a bottleneck, and more time is required for evaluation. Therefore, as shown in FIG. 3, the wireless communication system according to the embodiment of the present invention adopts a configuration in which the whole network environment 100 where the multiple links L exist is divided into multiple areas 102, and control apparatuses (indicated by white circles in FIG. 3) 150 in charge of their respective areas 102 independently perform beam configuration optimization for the divided areas 102 in parallel.

Influence of interference electromagnetic waves among wireless links L in each area 102 is reduced by, during the optimization process, performing beam and null steering while evaluating communication qualities of the multiple wireless links L simultaneously. On the other hand, even if an area targeted by optimization is logically divided, areas 102 adjoining each other are not physically separated, and, therefore, the possibility still exists that the adjoining areas 102 mutually generate interference electromagnetic waves N.

Therefore, in the wireless communication system according to the embodiment of the present invention, a control apparatus 150a (hereinafter, attention will be paid to control apparatus 150a, and area 102a for which the control apparatus 150a is in charge of beam configuration optimization will be referred to as an optimization area) performs evaluation of signal quality on the basis of radiation of electromagnetic waves in each of multiple wireless links L within the optimization area 102a, in a state that generation of interference electromagnetic waves from at least one wireless links in areas 102b to 102g adjoining the optimization area 102a (hereinafter, the areas adjoining the optimization area will be referred to as adjoining areas) is ensured. In this way, optimization of the beam configuration for area 102a is performed so that influence of interference electromagnetic waves from the adjoining areas 102b to 102g is reduced.

According to the above configuration, it is possible to shorten convergence time and perform efficient and accurate optimization of beam configuration of the whole space while reducing influence of interference among wireless links. At this time, beams are steered simultaneously at the wireless links to perform the evaluation, and, therefore, the network topology within the optimization area 102a is not restricted.

In a particular embodiment, it is ensured that interference electromagnetic waves from an adjoining area are generated during the signal quality evaluation described above, by (1) requesting a node 110d of the adjoining area 102d to generate electromagnetic waves at a predetermined or higher rate per unit time to determine evaluation time, (2) acquiring current information about communication time per unit time from a node 110c of the adjoining area 102c to determine the evaluation time; or (3) receiving a notification from a control apparatus 150c of the adjoining area 102c that the control apparatus 150c will operate in an optimization mode.

Furthermore, in a preferred embodiment, the control apparatus 150a (4) can receive feedback of an evaluation result about influence of interference electromagnetic waves given from its optimization area 102a to the adjoining area 102e, from a node 110e of the adjoining area 102e and reflect the feedback on an evaluation result about the signal quality of its optimization area 102a. Thereby, optimization can be performed so that interference electromagnetic waves from wireless links L in the optimization area 102a to the adjoining area 102e are reduced.

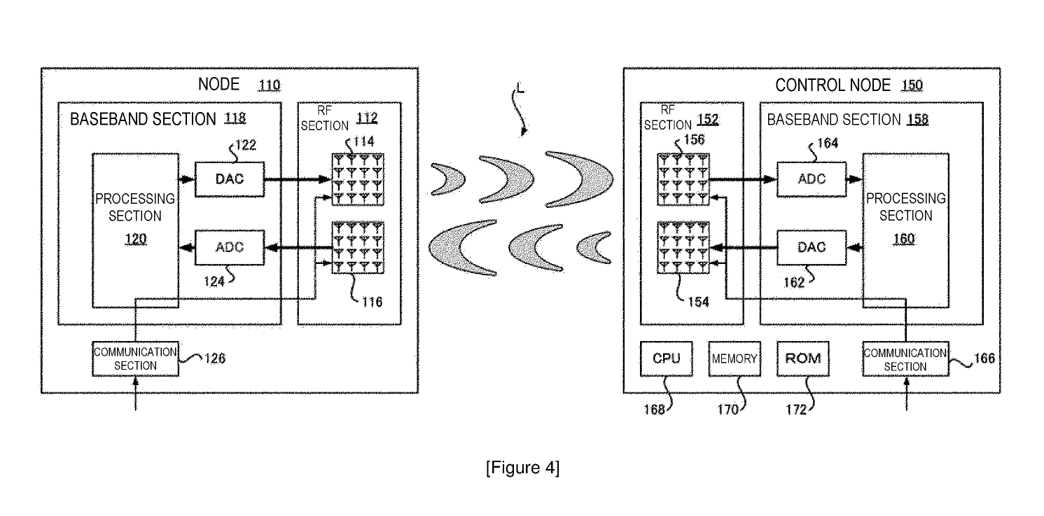

The wireless communication system that executes the optimization process according to the embodiment of the present invention will be described below in more detail with reference to FIGS. 4 to 8. FIG. 4 is a diagram showing hardware configurations of nodes 110 and 150 in the wireless communication system according to the embodiment of the present invention. In the described embodiment, a predetermined node also plays a role of a control apparatus that executes the optimization process, and such a node 110 will be referred to as control node 150.

Node 110 shown in FIG. 4 is configured such that it includes an RF (Radio Frequency) section 112 in charge of analog processing, a baseband section 118 in charge of digital processing, and communication section 126.

RF section 112 includes transmitting-side (Tx) and receiving-side (Rx) phased arrays 114 and 116, and these are connected to baseband section 118. As phased arrays 114 and 116, array antennas having various forms, such as linear arrays, planar arrays, circular arrays and conformal arrays, can be used although phased arrays 114 and 116 are not limited thereto.

Each of phased arrays 114 and 116 is configured such that it includes multiple antenna elements, and parameters such as phase and gain are set independently for each of the antenna elements. By adjusting the parameters of each antenna elements, the directions of beams radiated from phased arrays 114 and 116 and radiation patterns can be controlled. The transmitting-side phased array 114 converts an inputted electrical signal to electromagnetic waves and radiates the electromagnetic waves into space. The receiving-side phased array 116 receives the electromagnetic waves propagated through the space, converts the electromagnetic waves to an electrical signal and outputs the electrical signal.

RF section 112 is a circuit block that processes a signal in the wireless frequency band of a carrier. RF section 112 modulates an inputted baseband signal to an electrical signal of the RF frequency band on the basis of a carrier signal and outputs the electrical signal to phased array 114. RF section 112 also demodulates an electrical signal of the RF frequency band inputted from phased array 116 to a baseband signal on the basis of a carrier signal.

Baseband section 118 is a circuit block that processes a baseband signal that has not been modulated yet or that has been demodulated. More specifically, baseband section 118 is configured such that it includes processing section 120, DAC (Digital to Analog Converter) 122 and ADC (Analog to Digital Converter) 124. Processing section 120 modulates transmit data inputted from an upper layer according to an adopted modulation method to generate a transmit baseband signal, and outputs the transmit baseband signal to RF section 112 via DAC 122. Processing section 120 receives the receive baseband signal demodulated by RF section 112 via ADC 124, restores the receive data according to the modulation method and outputs the receive data to the upper layer.

Communication section 126 is a network interface for communicating with an external control node 150 or another node 110. As the network interface, a wireless LAN (Local Area Network) such as Wifi (Wireless Fidelity), near-field wireless communication such as Zigbee® and Bluetooth®, and a wireless module for a mobile communication network such as 3G and LTE (Long Term Evolution) can be given as examples.

Communication section 126 receives parameters from an external control node 150 and sets the parameters for each of the antenna elements of phased arrays 114 and 116 via processing section 120. Communication section 126 also transmits an evaluation result about signal quality measured on its own wireless link to external control node 150. Since the amount of these pieces of information is small, communication section 126 can use a communication interface with a lower speed than that of a wireless link L to be established.

Similar to node 110, control node 150 is also provided with basic components such as RF section 152, phased arrays 154 and 156, a baseband section 158, processing section 160, DAC 162, ADC 164 and communication section 166.

Control node 150 is configured such that it further includes CPU 168, memory 170 and ROM 172 as hardware for executing the optimization process according to the embodiment of the present invention, in addition to the above components. By reading out a control program in which the optimization process according to the embodiment of the present invention is written, from ROM 172 and developing the control program in a work space provided by memory 170, control node 150 realizes each function section and the optimization process to be described later, under the control of CPU 168.

In the embodiment shown in FIG. 4, the optimization process will be described on the assumption that it is realized by CPU 168 as software. Implementation of the optimization process, however, is not limited, and hardware implementation by an application-specific integrated circuit, a programmable logic device or the like is also possible.

Node 110 and control node 150 shown in FIG. 4 establish a predetermined wireless link L by mutually adjusting each parameter of each of antenna elements of their phased arrays 114 and 116 and phased arrays 154 and 156 according to the optimization process. In the described embodiment, wireless link L is configured as a full-duplex single-channel wireless link. However, wireless link L is not limited thereto. In another embodiment, it can be a multiple-channel wireless link or can be a half-duplex wireless link or a one-way wireless link. It can be noted that, in the description below, the nodes can be referred to as a transmitting-side node and a receiving-side node to indicate their roles on the assumption of one-way communication, for convenience of explanation, regardless of the wireless link being full-duplex communication, half-duplex communication or one-way communication.

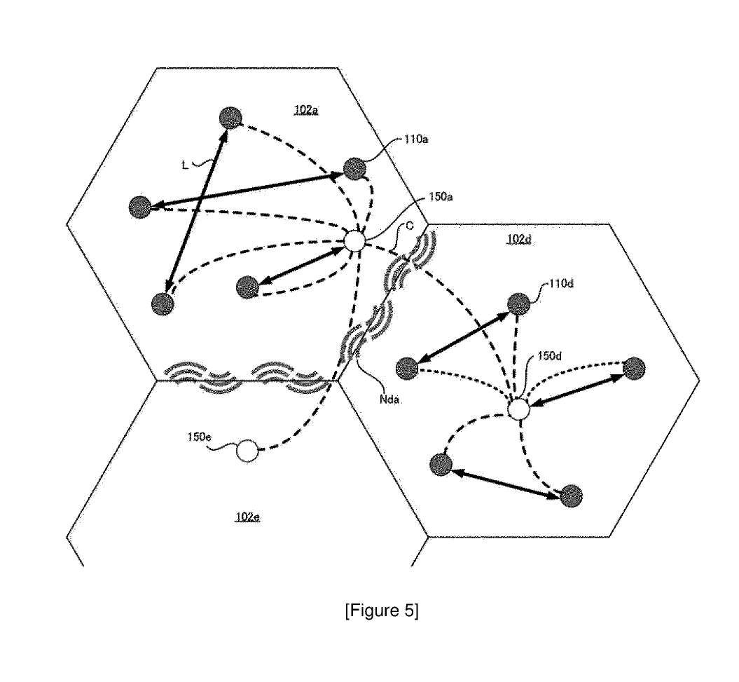

FIG. 5 is a diagram illustrating a control plane C connecting nodes 110 and 150 in network environment 100 according to the embodiment of the present invention. In the example shown in FIG. 5, a star network topology with control node 150 as a center is provided in area 102. Between two areas 102, communication is performed between control nodes 150 arranged in their respective areas 102. Control node 150a acquires, from node 110a constituting a wireless ink in optimization area 102a of control node 150a, an evaluation result about the signal quality of the wireless link via the control plane C. Further, control node 150a can perform the above-described request for generation of interference electromagnetic waves to, acquisition of communication time information from, and acquisition of feedback of an evaluation result about influence of interference electromagnetic waves on an adjoining area from node 110d constituting a wireless link in the adjoining area 102d via control node 150d.

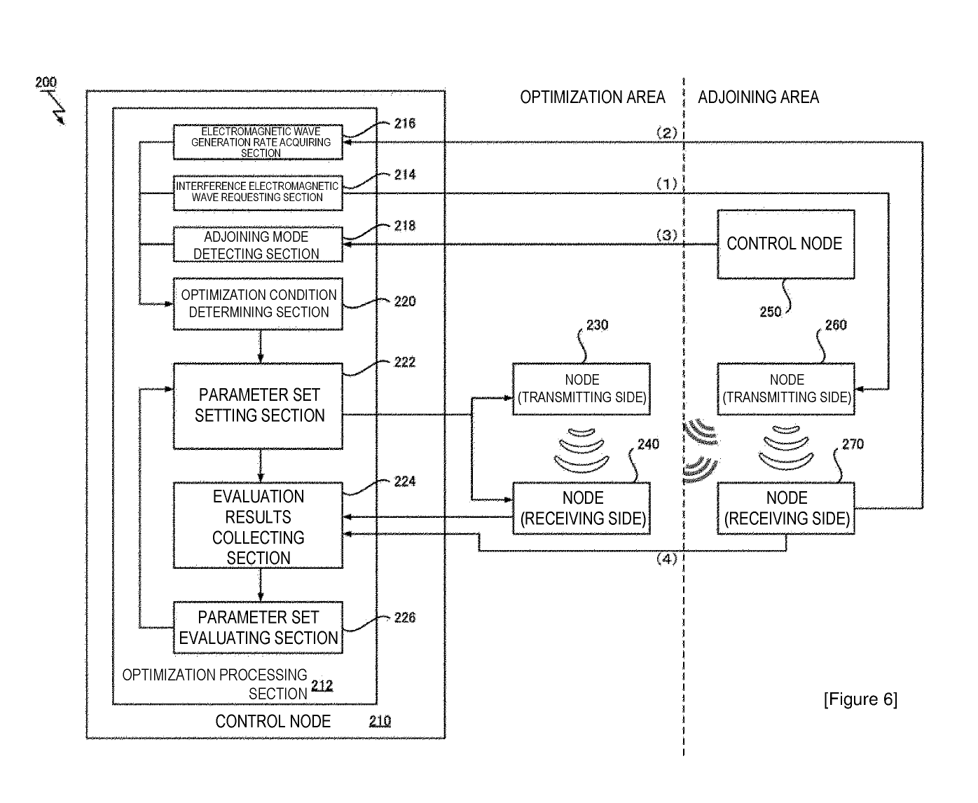

In the described embodiment, a communication interface different from the millimeter wave wireless link will be described as what is connected to the control plane by communication section 126. However, the connection is not limited thereto, and a network of different communication means is not necessarily required if communication via direct or indirect wireless link between node 110 and control node 150 can be secured. For example, in another embodiment, the control plane can be formed by a mesh network of wireless links L. A functional configuration for realizing the optimization process according to the embodiment of the present invention will be described below with reference to FIG. 6. FIG. 6 is a diagram showing functional blocks of a wireless communication system 200 according to the embodiment of the present invention. FIG. 6 shows functional block 210 realized on control node 150 in an optimization area to be noticed. In addition, FIG. 6 shows other nodes 230 and 240 in the optimization area to be noticed, control node 250 and other nodes 260 and 270 in an adjoining area.

Functional block 210 of control node 150 is configured such that it includes optimization processing section 212 that executes the optimization process for the beam configuration of an area functional block 210 is in charge of. More specifically, optimization processing section 212 is configured such that it includes interference electromagnetic wave requesting section 214, electromagnetic wave generation rate acquiring section 216, adjoining mode detecting section 218, optimization condition determining section 220, parameter set setting section 222, evaluation results collecting section 224 and parameter set evaluating section 226. Since each control node 150 independently operates in an area that it is in charge of, the optimization process is not necessarily performed in an adjoining area while the optimization process is being executed in the optimization area to be noticed. In the case of being in a normal mode, there is a possibility that packets are not transmitted almost at all, and electromagnetic wave interference from an adjoining area is not generated almost at all. If the optimization process is performed in such a situation, the beam configuration is adjusted without influence of interference from an adjoining area being taken account of. Therefore, it can happen that, each time a packet is generated in a wireless link in an adjoining area, communication quality can be degraded by being influenced by interference electromagnetic waves.

Therefore, interference electromagnetic wave requesting section 214 requests transmitting-side node 260 constituting at least one wireless links in at least one adjoining area to ensure generation of interference electromagnetic waves so that a specified electromagnetic wave generation rate is satisfied, on the basis of physical position information about nodes set in advance. Receiving the request, transmitting-side node 260 inserts a dummy packet, a scramble pattern or the like to perform communication so that the specified electromagnetic wave generation rate is ensured even while its normal communication is not performed.

Thereby, it becomes possible to evaluate signal quality in the state that interference electromagnetic waves from an adjoining area are generated described above. As for the request-destination wireless link, a link positioned near a border with the optimization area or a link in a direction toward the optimization area can be selected on the basis of the physical position information set in advance. In this case, optimization condition determining section 220 determines an evaluation period during which interference electromagnetic waves are generated at least once, on the basis of the specified electromagnetic wave generation rate requested by interference electromagnetic wave requesting section 214.

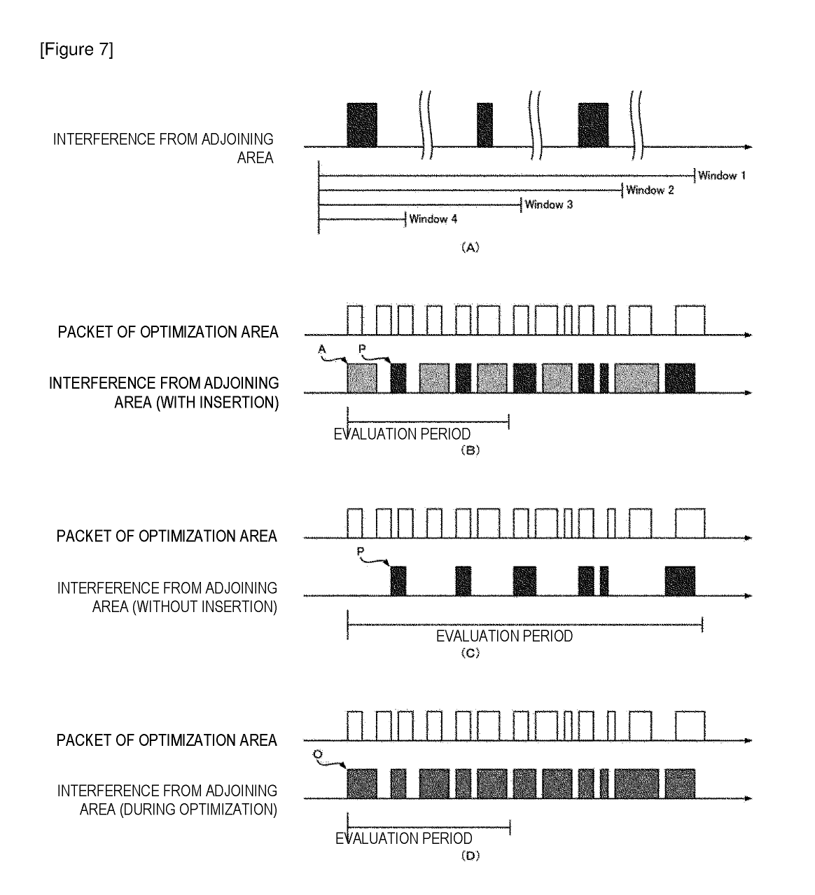

FIG. 7 is a diagram illustrating interference electromagnetic waves generated from an adjoining area to the optimization area in wireless communication system 200 according to the present embodiment, and a method for determining the evaluation time. FIG. 7(A) is a diagram illustrating the electromagnetic wave generation rate described above. Interference electromagnetic waves from an adjoining area are generated in accordance with a request for communication in the adjoining area, and the electromagnetic wave generation rate is defined as a rate of occupation by the total of communication time (in the FIG. 7, interference electromagnetic waves are indicated by black bars) in such a predetermined time window as shown in FIG. 7(A). At this time, there is a possibility that the calculated electromagnetic wave generation rate fluctuates depending on how the time window is set. In that case, for example, the most stable time window can be selected on the basis of values calculated for multiple time windows (windows 1 to 4). Further, by selecting the smallest time window among stable time windows, the evaluation time can be shortened.

FIG. 7(B) illustrates a method for determining the evaluation time in the case where interference electromagnetic wave requesting section 214 requests the specified electromagnetic wave generation rate, which has been described above. As shown in FIG. 7(B), interference electromagnetic waves from an adjoining area include insertion A of dummy packets or scramble patterns inserted to satisfy the specified electromagnetic wave generation rate, in addition to packets P generated in accordance with normal requests. At this time, since it is possible to estimate a time during which at least one time of generation of interference electromagnetic waves can be statistically ensured, from the specified electromagnetic wave generation rate, optimization condition determining section 220 determines time equal to or longer than the time as the evaluation time. In the case of requesting the electromagnetic wave generation rate, interference is generated by the insertion A, and, therefore, the evaluation time can be shortened in comparison with the case where the insertion is not performed.

In order to improve the accuracy of optimization, it is preferable to request nodes in more adjoining areas to generate interference electromagnetic waves, specifying a higher electromagnetic wave generation rate. However, by making the request to nodes in more adjoining areas and specifying a higher electromagnetic wave generation rate, excessive electromagnetic waves are forced to be radiated, and influence on the adjoining areas increases. Further, excessive power consumption is caused. Therefore, it is desirable to determine the number of nodes to be requested and the specified electromagnetic wave generation rate in consideration of balance between the desired accuracy of optimization and power consumption or magnitude of influence.

Here, FIG. 6 will be referred to again. In comparison with the above, electromagnetic wave generation rate acquiring section 216 does not request assurance of generation of interference electromagnetic waves but requests node 260 or 270 constituting at least one wireless links in an adjoining area to acquire the electromagnetic wave generation rate, on the basis of the physical position information about nodes and the like. If node 270 constituting the wireless links in the adjoining area, which has received the request, is a receiving-side node, it calculates time of communication from its counterpart per unit time (the electromagnetic wave generation rate) and transmits the calculated electromagnetic wave generation rate to the request-source control node 150. If node 260 is a transmitting-side node, node 260 calculates time of communication to its counterpart per unit time (the electromagnetic wave generation rate) and transmits the calculated electromagnetic wave generation rate. In this case, optimization condition determining section 220 determines an evaluation period during which interference electromagnetic waves are generated at least once, on the basis of the electromagnetic wave generation rate acquired by electromagnetic wave generation rate acquiring section 216.

FIG. 7(C) illustrates a method for determining the evaluation time in the case where electromagnetic wave generation rate acquiring section 216 acquires the electromagnetic wave generation rate, which has been described above. In this case, as shown in FIG. 7(C), interference electromagnetic waves from an adjoining area include only ordinary packets P in the adjoining area. At this time, since it is possible to estimate time during which at least one time of generation of an interference electromagnetic waves can be statistically ensured, from the acquired electromagnetic wave generation rate, time equal to or longer than the time is determined as the evaluation time. Thereby, it is possible to reduce influence on the adjoining area from the optimization area for which the optimization process is being performed. Further, since excessive electromagnetic waves are not generated, power consumption is not much. Here, FIG. 6 will be referred to again. As described above, each control node 150 independently operates in an area that it is in charge of. However, a situation is also conceivable in which the optimization process is simultaneously performed in adjoining areas, such as a case where an optimization instruction is broadcast to multiple areas.

FIG. 7(D) illustrates a method for determining the evaluation time in the case where an adjoining area is in the optimization mode. In this case, as shown in FIG. 7(D), the situation is such that influence of interference electromagnetic waves from an adjoining area is given by transmission of a packet O for performing optimization in the adjoining area even if assurance of the electromagnetic wave generation rate as described above is not requested. That is, generation of interference electromagnetic waves from the adjoining area is substantially ensured. Therefore, adjoining mode detecting section 218 receives a notification about whether the mode of the adjoining area is the optimization mode or the normal mode, from control node 250 of the adjoining area. Then, optimization condition determining section 220 only has to set appropriate evaluation time during which signal quality can be statistically evaluated.

Here, FIG. 6 will be referred to again. Parameter set setting section 222, evaluation results collecting section 224 and parameter set evaluating section 226 execute a process for optimizing a parameter set that includes parameters (gain and phase) of each antenna element of phased arrays constituting all the wireless links in the optimization area in accordance with a search algorithm. As the search algorithm, an optimization algorithm known as a swarm intelligent algorithm or an evolutionary algorithm, such as a particle swarm optimization algorithm, a genetic algorithm and an ant colony optimization algorithm, can be adopted although the search algorithm is not especially limited thereto. In accordance with the search algorithm described above, parameter set setting section 222 sets the parameter set for all the wireless links in the optimization area to set values calculated from an algorithm update formula.

Evaluation results collecting section 224 collects, from receiving-side nodes 240 constituting the wireless links in the optimization area, evaluation results about the quality of communications of the respective wireless links that have been actually performed under the set values of the parameter set described above. Further, in a preferred embodiment, evaluation results collecting section 224 collects, from receiving-side nodes 270 constituting the wireless links in an adjoining area, feedback of evaluation results about interference electromagnetic waves from the optimization area caused by communication between wireless links that has been actually performed under the set values of the parameter set described above.

Parameter set evaluating section 226 evaluates the set antenna parameter set on the basis of electromagnetic wave radiation in each of the multiple wireless links in the optimization area. Evaluation of the parameter set is performed on the basis of a result of comprehensively evaluating the signal quality of actual communication performed in each of predetermined wireless links during the evaluation period during which generation of interference electromagnetic waves from at least one wireless links in an adjoining area is ensured, which has been described above. In the case where feedback of the evaluation results about interference electromagnetic waves to the adjoining area is collected in the preferred embodiment, parameter set evaluating section 226 can further reflect the evaluation results about interference electromagnetic waves on the evaluation result about the signal quality.

Further, as described above, it can be said that the larger the number of wireless links in the adjoining area from which generation of interference electromagnetic waves was requested or from which the electromagnetic wave generation rate was acquired is, the higher the accuracy of optimization is. Therefore, in the preferred embodiment, the number of wireless links in the adjoining area from which generation was requested or from which the electromagnetic wave generation rate was acquired can be applied as the degree of reliability of the evaluation result about the signal quality of the optimization area. For example, even if parameter sets with almost the same signal quality are obtained when optimization is performed multiple times with a different number of wireless links, a parameter set for which the number of wireless links from which generation of interference electromagnetic waves was requested or from which the electromagnetic wave generation rate was acquired is larger can be preferentially adopted as a parameter set with a high reliability.

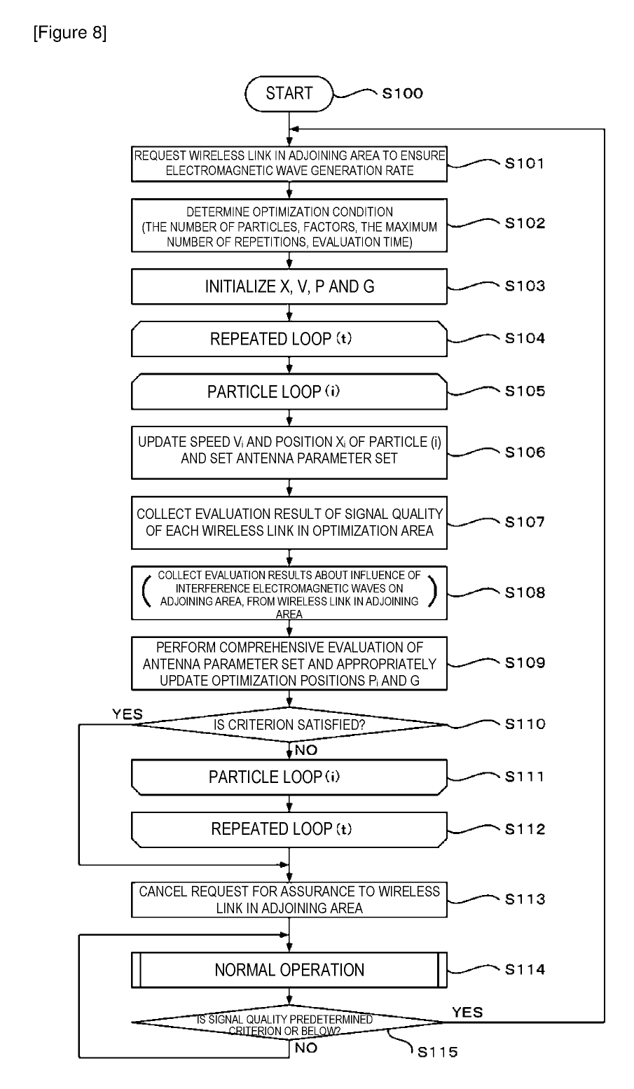

In wireless communication system 200 according to the embodiment of the present invention, each control node 150 independently repeats setting of a parameter set for an area that control node 150 is in charge of and evaluation of the parameter set to optimize the beam configuration of each area that control node 150 is in charge of, under a condition that interference electromagnetic waves from an adjoining area are ensured. Thereby, the beam configuration of the whole space is optimized in consideration of influence of interference electromagnetic waves between adjoining areas. The optimization process according to the embodiment of the present invention will be described below in more detail with the use of a specific algorithm, with reference to FIG. 8. FIG. 8 is a flowchart showing the optimization process executed by control node 150 according to the embodiment of the present invention. The optimization process shown in FIG. 8 is in accordance with a particle swarm optimization algorithm. Further, the example shown in FIG. 8 corresponds to the case where generation of interference electromagnetic waves is required from a wireless link in an adjoining area.

The process shown in FIG. 8 starts at step S100 in response to an instruction from a network administrator, the initial boot at the time of introducing the system, detection of a newly added node or arrival of a scheduled date and time. At step S101, control node 150 requests assurance of generation of interference electromagnetic waves at a specified electromagnetic wave generation rate from at least one wireless links in at least one adjoining area by interference electromagnetic wave requesting section 214 and starts the optimization process.

At step S102, control node 150 determines optimization conditions including the number of particles of the particle swarm optimization algorithm, various factors, the maximum number of repetitions and evaluation time by optimization condition determining section 220. The maximum number of repetitions is an upper-limit value of repetitions for discontinuing the optimization process of the algorithm. The evaluation time is calculated on the basis of a specified electromagnetic wave generation rate as described above.

Here, the particle swarm optimization (PSO) algorithm will be described. The PSO algorithm is such an algorithm that multiple particles indicating solutions to be optimized are arranged in search space, and the particles move in the search space to search for an optimal position with the highest goodness of fit. Each particle has a speed and a position and is indicated by an N-dimensional vector. Speeds V and positions X of M particles are indicated by an M×N array by formulas (1) and (2) below.

[Math 1]

V=[vᵢⱼ](1≦i≦M,1≦j≦N) (1)

X=[xᵢⱼ](1≦i≦M,1≦j≦N) (2)

Each component of the N-dimensional vector indicates a parameter of the search space. When the position of a particle i is indicated by an N-dimensional vector Xᵢ, the position vector Xᵢ includes a gain parameter and a phase parameter of each antenna element of all phased arrays of all the wireless links in the optimization area as elements. Here, when consideration is made with regard to S, the number of one-way links each of which is constituted by one transmitting-side phased array and one receiving-side phased array, the number of dimensions N is expressed by the following formula (3) when it is assumed that the number of parameters of each antenna element is two, that is, phase and gain; that there are two antennas, transmitting-side and receiving-side antennas, for each link; and that there are E elements for each antenna.

[Math 2]

N=2×2×E×S (3)

Each particle i remembers an optimal position Pᵢ that the particle i has found. The particles communicate with one another and share an optimal position G that the particles have found as the whole of the particles. In the described embodiment, an all-combined type topology in which all the particles are combined with one another is used for convenience of description. In another embodiment, a ring-type or tree-type topology can be used. The optimal position P of each particle and the optimal position G of the whole of the particles are expressed by the following formulas (4) and (5).

[Math 3]

P=[xᵢⱼ](1≦i≦M,1≦j≦N) (4)

G=[xⱼ](1≦j≦N) (5)

In the PSO algorithm, the matrixes X, V, P and G described above are repeatedly updated by each repeated loop while the position of each particle is being evaluated. The speed V and position X of each particle are updated in accordance with the following update formulas (6) and (7).

[Math 4]

Vᵢⱼ(t)=wVᵢⱼ(t−1)+c₁R₁(t)(Pᵢⱼ(t−1)−Xᵢⱼ(t−1))+c₂R₂(t)(Gⱼ(t−1)−Xᵢⱼ(t−1)) (6)

Xᵢⱼ(t)=Xᵢⱼ(t−1)+Vᵢⱼ(t) (7)

Here, t indicates an index identifying a repeated loop. Current particle speed V(t) is determined from immediately previous particle speed V(t−1) and particle position X(t−1) in accordance with the above formula (6). Then, the current particle position X(t) is changed on the basis of the speed V(t) and the immediately previous particle position X(t−1) in accordance with the above formula (7). In the above update formulas (6) and (7), w, c₁ and c₂ indicate an inertia factor, a factor of particle speed to the optimal position P of each particle, and a factor of particle speed to the optimal position G of the whole of the particles, respectively, which are set in advance. As for R₁ and R₂, values are randomly selected from a range from 0 to 1 in each repeated loop and each component of the speed vector of each particle. At step S102 described above, the factors w, c₁ and c₂ are determined as factors for optimization conditions.

At step S103, control node 150 initializes the particle position X, the particle speed V, the optimal position P of each particle and the optimal position G of the whole of the particles by parameter set setting section 222. Basically, each of the position X, the speed V, the optimal positions P and G can be initialized with random values. An initialization method is not especially limited. Loops indicated by steps S104 and S112 are repeated loops (t) and are repeated the number of times corresponding to the maximum number of repetitions determined at step S102 at the maximum. Loops of steps s105 and S111 are particle loops (i) and repeated M times in one repeated loop (t).

At step S106, control node 150 updates the speed Vᵢ and position Xᵢ of the particle i in accordance with the above update formulas (6) and (7) and sets an antenna parameter set within the optimization area corresponding to the position Xᵢ by parameter set setting section 222. At this time, the parameter set is transmitted from control node 150 to each node 110 constituting each wireless link via the control plane C and is set for each antenna element of actual phased arrays. Though the parameters such as phase and gain are generally discrete values, they can be calculated as floating-point values in the PSO calculation.

At step S107, control node 150 causes the node of each wireless link in the optimization area to evaluate the quality of communication with the current parameter set for a predetermined evaluation time, and collects a signal quality evaluation result for each wireless link from the node of each wireless link by evaluation results collecting section 224.

In a preferred embodiment, at step S108, control node 150 causes nodes constituting wireless links in an adjoining area to evaluate the quality of communication, and collects feedback of evaluation results about influence of interference electromagnetic waves generated from the optimization area to the adjoining area, from the nodes constituting the wireless links in the adjoining area.

At step S109, control node 150 calculates the score of comprehensive evaluation of the antenna parameter set currently set, on the basis of the collected evaluation results about the signal quality of the respective wireless links, by parameter set evaluating section 226, and appropriately updates the optimal positions Pi and G. The score of the comprehensive evaluation can be calculated by calculating the sum of the collected signal quality evaluation results for all the respective wireless links in the optimization area, although the score is not limited thereto. If the score of comprehensive evaluation of the parameter set currently set (position Xᵢ) is higher than the score of comprehensive evaluation of the optimal position Pᵢ the particle i has found at the current point of time, the position Xᵢ of the particle i is set as the newest optimal position Pᵢ. If the score of comprehensive evaluation of the parameter set currently set (position Xᵢ) is higher than the score of comprehensive evaluation of the optimal position G of the whole of the particles at the current point of time, the position Xᵢ of the particle i is set as the newest optimal position G.

In the optimization process, if it is determined at step S110 that the optimal position G of the whole of the particles at the current point of time exceeds a convergence criterion (YES), the process exits the loop and is branched to step S113. When the maximum number of repetitions and the maximum number of particles are reached also, the process is similarly advanced to step S113.

At step S113, control node 150 notifies the wireless links in the adjoining area from which assurance of generation of interference electromagnetic waves has been requested, of cancellation of the request for assurance by interference electromagnetic wave requesting section 214. At step S114, an antenna parameter set corresponding to the final optimum position G of the whole of the particles is set, and the process transitions to a normal operation.

During the normal operation, at step S115, control node 150 monitors signal quality and determines whether or not the signal quality has reached a predetermined criterion or below. If it is determined at step S115 that the signal quality exceeds the criterion (NO), the process is looped to step S114 to continue the normal operation. On the other hand, if it is judged at step S115 that the signal quality has reached the predetermined criterion or below (YES), the process is looped to step S101 to re-execute the optimization process.

It is also conceivable to, in order to optimize the beam configuration in a predetermined network environment, calculate the radiation pattern of an antenna by simulation based on a physical theory and determine an optimal solution on a computer.

In the present techniques using a high frequency like millimeter waves, however, it is difficult to ensure linearity for an index value specified on a parameter register of an antenna array, and it is not possible to avoid unignorable variation among individuals. Further, it invites increase in cost to manufacture an antenna with an accuracy that can realize such narrow beams that are calculated by physical simulation in advance. Furthermore, it takes much time to accurately measure an omni-directional channel matrix required for the physical simulation even in the case of an environment in which positions are fixed. Therefore, it can be said that it is extremely difficult to acquire parameters that can be used in physical calculation in an actual environment for performing beam forming.

In comparison, according to the optimization process by the search algorithm described above, it is not necessary to take account of physical position information, physical information about interference electromagnetic waves, non-linearity of parameters, variation among individuals and the like, and it is possible to perform optimization if there is information about adjustable parameters of an antenna array. Further, since the calculation itself is easy, hardware implementation is also easy, and the optimization process can be said to be suitable for optimization of a phased array.

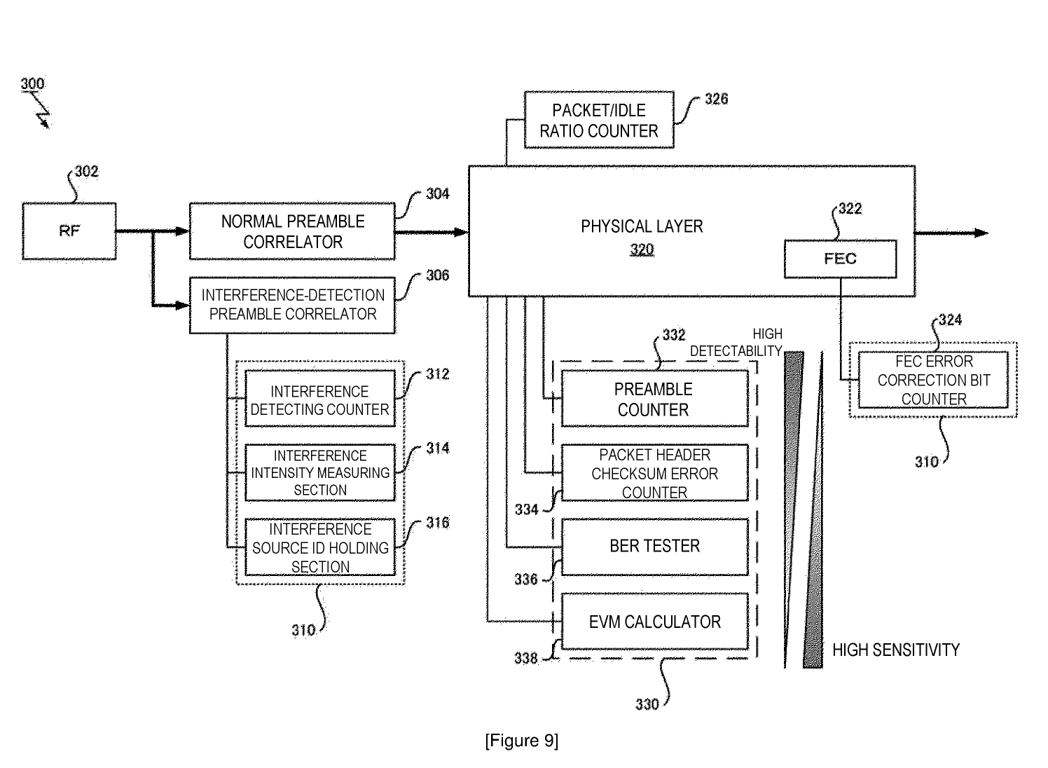

A receiving circuit configuration of a node according to a preferred embodiment as well as a method for evaluating interference electromagnetic waves to an adjoining area and a method for evaluating the signal quality of the optimization area will be described below with reference to FIGS. 9 to 11. FIG. 9 is a diagram showing a receiving-side circuit configuration of a node constituting a wireless link according to the preferred embodiment.

Receiving-side circuit configuration 300 of the node is configured such that it includes RF section 302, normal preamble correlator 304 and physical layer 320. Normal preamble correlator 304 is used during the normal operation mode and during the optimization mode, and it determines correlation with a predetermined preamble sequence and detects its own signal in its own area. Physical layer 320 is used in the normal operation mode, and it performs detection of its own signal and decoding of the signal. Physical layer 320 includes FEC (Forward Error Correction) 322, and FEC 322 corrects an error of its own signal, for example, using a forward error correction code such as a Reed-Solomon code. Further, packet/idle ratio counter 326 is connected to physical layer 320. Packet/idle ratio counter 326 counts the number of bits of a packet per predetermined time in normal communication to calculate the electromagnetic wave generation rate described above.

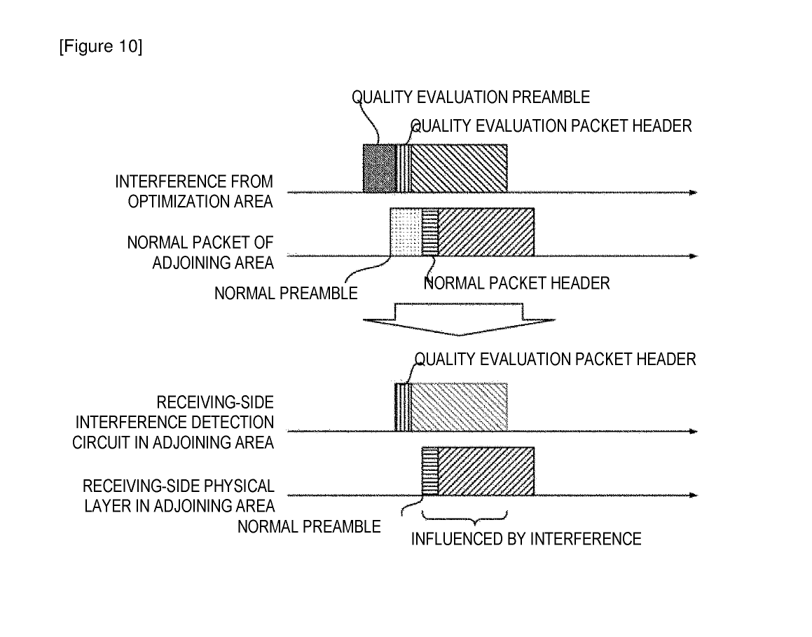

As described above, in the preferred embodiment, control node 150 collects feedback of evaluation results about influence of interference electromagnetic waves generated from the optimization area control node 150 is in charge of to an adjoining area, from nodes in the adjoining area. In the preferred embodiment, receiving-side circuit configuration 300 of the node is provided with an interference electromagnetic wave evaluation circuit for evaluating influence of interference electromagnetic waves from the optimization area as a node in an adjoining area, separately from the normal baseband circuit, as shown in FIG. 9. A method for evaluating influence of interference electromagnetic waves from the optimization area to an adjoining area in the preferred embodiment will be described below with reference to FIGS. 9 and 10.

In the preferred embodiment, a transmitting-side node constituting a wireless link in the optimization area transmits a signal quality evaluation packet as a signal that can be separated from normal data signals, using a special preamble for quality evaluation, a special orthogonal code or identification information for each area or each node. To respond thereto, a receiving-side node constituting a wireless link in an adjoining area is configured such that it includes interference-detection preamble correlator 306, interference detecting counter 312, interference intensity measuring section 314, interference source ID holding section 316 as receiving-side circuit configuration 300 separately from the circuit for processing packets of a normal data signal described above.

Interference-detection preamble correlator 306 determines correlation with an interference-detection preamble sequence and detects an interference noise signal from an adjoining optimization area. Interference detecting counter 312 counts the number of preambles in interference signals per unit time. As more interference noise signals are detected, influence of interference electromagnetic waves is larger. Interference intensity measuring section 314 measures the signal strength of an interference noise signal. Interference source ID holding section 316 holds the ID of an interference source that generates the strongest interference noise.

FIG. 10 is a diagram illustrating a packet that a receiving-side node in an adjoining area receives. As shown in FIG. 10, there is a possibility that the receiving-side node in the adjoining area receives a quality evaluation packet from an adjoining area (the optimization area) in addition to normal packets from a transmission-side node of a counterpart in its own area (an adjoining area when seen from the control node in the optimization area). In comparison with a normal packet having a normal preamble and a normal packet header, an interference electromagnetic wave from the adjoining area (the optimization area) includes a quality evaluation preamble and a quality evaluation packet header. The receiving-side node in the adjoining area detects a signal quality evaluation packet on the basis of the quality evaluation preamble, in the interference electromagnetic wave evaluation circuit. Then, by regarding this quality evaluation packet as an interference electromagnetic wave, an evaluation result about influence of the interference electromagnetic wave is generated by interference detecting counter 312, interference intensity measuring section 314 and interference source ID holding section 316 which are surrounded by a dotted-line rectangle 310. The node provides feedback of the evaluation result to control node 150 in the adjoining optimization area via the control plane C.

Receiving the feedback, parameter set evaluating section 226 of control node 150 in the optimization area performs comprehensive evaluation, including the evaluation result about interference of the electromagnetic wave into an evaluation result of signal quality of the optimization area that it is in charge of. Parameter set evaluating section 226 imposes penalty on the score of the comprehensive evaluation of the signal quality, on the assumption that influence on other areas is larger as the value of the interference detecting counter is larger and the interference intensity is larger, in order that interference electromagnetic waves do not reach the adjoining area. Further, heavier penalty can be imposed on the signal quality of a node corresponding to an ID indicating the strongest interference source. As shown in FIG. 10, the receiving-side node in the adjoining area separates a normal packet from a signal quality evaluation packet to process the normal packet. However, there is a possibility that the normal packet is influenced by an interference electromagnetic wave by a temporally overlapping signal quality evaluation packet.

Therefore, in the preferred embodiment, the node is provided with an FEC error correction bit counter 324 surrounded by the dotted-line rectangle 310 as receiving-side circuit configuration 300. Even if a minor error occurs in a normal packet, FEC 322 corrects the error on the basis of its redundancy. FEC error correction bit counter 324 counts the number of bits corrected by FEC 322 in physical layer 320, measures influence given to normal communication by influence of the interference electromagnetic waves, and generates an evaluation result about influence of the interference electromagnetic waves. In response thereto, parameter set evaluating section 226 in the optimization area imposes penalty on the score of the comprehensive evaluation of the signal quality on the assumption that the larger the number of corrected bits is, the larger the influence given to other areas is.

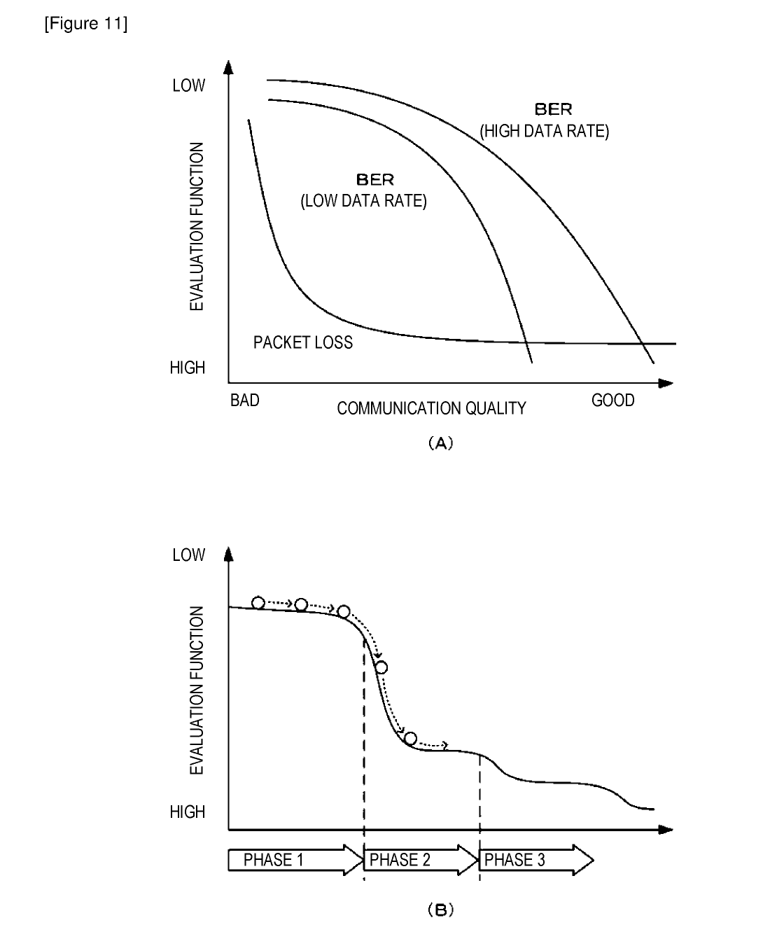

As described above, by providing the interference electromagnetic wave evaluation circuit separately from the normal wireless baseband circuit and adopting such a configuration that an evaluation packet from which an interference electromagnetic wave can be separated is transmitted, it becomes possible to perform optimization without giving influence to operations of other areas as far as possible. Further, by receiving feedback of interference electromagnetic waves caused by the optimization area from an adjoining area, it becomes possible to perform optimization so that influence on the adjoining area is reduced more. A method for evaluating the signal quality of the optimization area in the preferred embodiment will be described below with reference to FIGS. 9 and 11.

A transmitting-side node constituting a wireless link in the optimization area transmits a signal quality evaluation packet during the optimization mode. To respond thereto, receiving-side circuit configuration 300 of a node is provided with evaluation function 330 for evaluating the signal quality evaluation packet, as a receiving-side node constituting the wireless link in the optimization area. In the search algorithm such as the PSO algorithm described above, an evaluation function for evaluating the goodness of fit of a set parameter set is not specially restricted. The evaluation function only has to be such that can evaluate, by comparing the goodness of fit of the current parameter set with the goodness of fit of the optimal parameter set that has been found, which is more fit. Therefore, it is possible to evaluate signal quality for each wireless link, for example, using a single evaluation function such as a bit error rate and compare the signal qualities.

On the other hand, in the case of using highly directional electromagnetic waves such as millimeter waves, the signal quality is very high if the directivities of antennas on transmitting and receiving sides correspond to each other. When the directivities are displaced from each other even only slightly, however, the signal quality rapidly deteriorates. In an area where the directivities are greatly displaced from each other, it is difficult to significantly evaluate difference in goodness of fit even if parameters are changed. That is, in the case of using highly directional electromagnetic waves such as millimeter waves, it is preferable to be compatible with a wide dynamic range of signal quality.

FIG. 11(A) is a diagram illustrating multiple evaluation functions having different detection accuracies for signal quality. As shown in FIG. 11(A), although the accuracy of detection of packet loss is high in an area where signal quality is bad, the detection accuracy is low in an area where signal quality is improved. In comparison, as for a bit error rate (BER), the detection accuracy is high where signal quality is improved to some extent. Further, even in the case of the same BER, the detection accuracy is higher on the side where signal quality is improved less when the data rate of a transmit packet is low in comparison with the case where the data rate is high. In order to evaluate signal quality highly accurately, it is preferable to selectively use such multiple evaluation functions having different detection sensitivities according to signal quality as appropriate.

Therefore, a receiving-side node constituting a wireless link in the optimization area according to the preferred embodiment is provided with multiple evaluation functions 332 to 338 having different detection sensitivities according to signal quality as receiving-side circuit configuration 300. In evaluation, an evaluation result about the signal quality of a wireless link by an evaluation function according to the signal quality, among the multiple evaluation functions, can be used. In a particular embodiment, preamble counter 332, packet header checksum error counter 334, BER tester 336 and EVM (Error Vector Magnitude) calculator 338 are included as the evaluation functions. Each evaluation function has linear detection accuracy within an appropriate operation range. On the right side of the evaluation functions 332 to 338 in FIG. 9, detectability and sensitivity are shown as characteristics of the evaluation functions.

Preamble counter 332 is an evaluation function that counts the number of detected preambles of its own signal per unit time, and it is a function the detectability and sensitivity of which are relatively high and low, respectively. Preamble counter 332 and packet header checksum error counter 334 are the evaluation functions for detecting packet loss shown in FIG. 11(A). Packet header checksum error counter 334 is an evaluation function for counting the number of packet header errors per unit time, and it is an evaluation function the detectability and sensitivity of which are lower and higher, respectively, than preamble counter 332. BER tester 336 is an evaluation function for measuring a bit error rate for an already-known transmit pattern, and it is an evaluation function the detectability and sensitivity of which are relatively low and high, respectively. EVM calculator 338 is an evaluation function for calculating the strength of an error vector, and it is an evaluation function the detectability and sensitivity of which are relatively low and high, respectively.

In the case of using multiple evaluation functions, the evaluation functions can be uniformly compared by standardizing each of the multiple evaluation functions or by weighting each of the multiple evaluation functions. In the case of using a single evaluation function, the calculated pieces of goodness of fit can be immediately compared. FIG. 11(B) is a diagram schematically illustrating how to use multiple evaluation functions. As shown in FIG. 11(B), for example, by dividing the whole optimization process into multiple phases and using, at each phase, an appropriate evaluation function having an operation range corresponding to the signal quality at that time point, it is possible to shorten convergence time and efficiently search for an optimal position of the whole.

As for which evaluation function among multiple evaluation functions is to be used, for example, the same evaluation function can be selected for all the wireless links in the optimization area on the basis of the score of comprehensive evaluation of the signal quality at the current optimization position G in the optimization area as shown in FIG. 11(B). Otherwise, an evaluation function can be independently selected in evaluation of the signal quality for each wireless link. In that case, the signal quality is evaluated for each wireless link by a uniform criterion (for example, BER), and an evaluation function for performing actual evaluation can be determined on the basis of the evaluation value.

Further, in the preferred embodiment described above, the multiple evaluation functions are prepared by changing the kind of evaluation function. However, the way of preparation is not limited thereto. As it is shown in FIG. 11(A) that the same BER behaves differently according to the characteristics of a transmit packet, the degree of how easily an error occurs also differs according to the data rate of a quality evaluation packet from a transmitter. Therefore, in an area with a low signal quality, a quality evaluation packet can be transmitted at a low data rate to perform evaluation; and, in an area with a relatively high signal quality, a quality evaluation packet can be transmitted at a high data rate to perform evaluation. That is, the multiple evaluation functions can be prepared by combinations of the kind of evaluation function and the characteristics of quality evaluation packet.

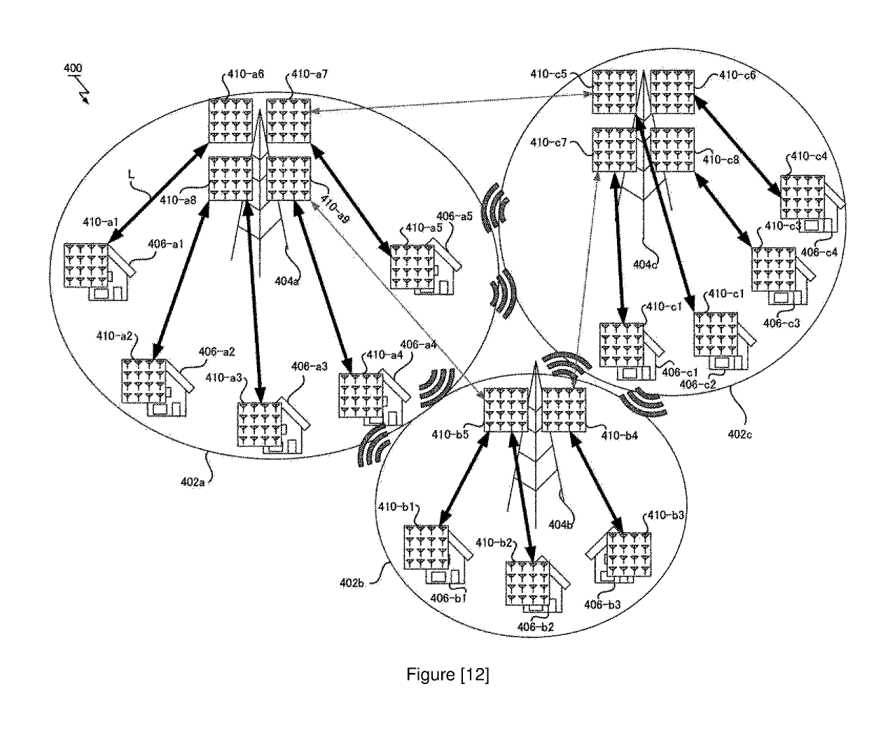

An application example of a network to which the optimization method according to the embodiment of the present invention can be applied will be described below with reference to FIG. 12. FIG. 12 is a diagram showing an application example of a wireless communication system to which the optimization method according to the embodiment of the present invention can be applied. FIG. 12 shows home-use wireless broadband access network 400 as the wireless communication system.

In home-use wireless broadband access network 400 shown in FIG. 12, multiple base stations 404 and multiple home-use wireless broadband routers 406 constitute the wireless communication network. Each of base stations 404 and home-use wireless broadband routers 406 is provided with phased array 410, and a wireless link L is established between a predetermined home side and a predetermined base station side defined in advance. In home-use wireless broadband access network 400, the positions of base stations 404 and home-use wireless broadband routers 406 are typically fixed. In such home-use wireless broadband access network 400, each base station 404 and each home-use wireless broadband router 406 are allocated to multiple areas 402a to 402c obtained by dividing the whole 400 first on the basis of a physical position of installation. For each divided area, a control apparatus optimizes a beam configuration between phased array 410 of base station 404 and phased arrays 410 of home-use wireless broadband routers 406 constituting each of all the wireless links L in the area.

Such a wireless link covering two areas as shown in FIG. 12 is not targeted by the optimization process in the optimization area. However, it is possible to take account of such a wireless link during the optimization process for each area by separately establishing such a wireless link in advance and ensuring a predetermined electromagnetic wave generation rate in the wireless link covering areas during the optimization process in each area.

According to the embodiment described above, it is possible to provide a wireless communication system capable of efficiently optimizing the beam configuration of the whole space, taking account of influence of interference among wireless links, in a wireless communication network in which multiple wireless links each of which can independently perform communication exist, and communications of the multiple wireless links are established by space division with the same frequency; a control apparatus; an optimization method; a wireless communication apparatus and a program.

The above-described functions of the present invention can be realized by an apparatus-executable program written in an object-oriented programming language such as C++, Java®, Java® Beans, Java® Applet, JavaScript®, Perl, Python and Ruby, and the like; and the program can be stored into an apparatus-readable recording medium and distributed or can be transmitted and distributed. Otherwise, all or a part of the above-described function sections can be implemented, for example, on a programmable device (PD) such as a field programmable gate array (FPGA), or can be implemented as an application specific integrated circuit (ASIC), and the function sections can be distributed as circuit configuration data (bit stream data) to be downloaded to the PD to realize the above function sections on the PD and data written in HDL (Hardware Description Language), VHDL (Very high speed integrated circuit Hardware Description Language), Verilog-HDL or the like for generating circuit configuration data, by a recording medium.

An embodiment of the present invention has been described. The embodiment of the present invention, however, is not limited to the embodiment described above and can be changed within a range that one skilled in the art can think of, such as other embodiments, addition, alteration and deletion. Any aspect is to be included in the scope of the present invention as far as the operation/advantageous effects of the present invention can be obtained.

What is claimed is:

1. A wireless communication system comprising a control apparatus and multiple wireless links which are arranged in an area where the control apparatus is in charge of optimizing a beam configuration and each of which is independently communicable, the control apparatus comprising:
a setting section for setting an antenna parameter set for the multiple wireless links in the area the control apparatus is in charge of, in accordance with a search algorithm; and
an evaluating section for evaluating the antenna parameter set set by the setting section, on the basis of radiation of electromagnetic waves in each of the multiple wireless links in the area the control apparatus is in charge of, in a state that interference electromagnetic waves from at least one wireless link arranged in an adjoining area adjoining the area the control apparatus is in charge of are generated.

2. The wireless communication system according to claim 1, wherein the control apparatus further comprises:
a request section for requesting the at least one wireless link arranged in the adjoining area to generate electromagnetic waves so that a specified electromagnetic wave generation rate is satisfied; and
a determination section for determining an evaluation period during which it is ensured that interference electromagnetic waves are generated at least once, on the basis of the specified electromagnetic wave generation rate requested by the request section wherein the evaluating section performs evaluation of the antenna parameter set on the basis of an evaluation result of signal quality of the area the control apparatus is in charge of during the evaluation period.

3. The wireless communication system according to claim 1, wherein the control apparatus further comprises:
an acquisition section for acquiring electromagnetic wave generation rates in the at least one wireless links arranged in the adjoining area;
a determination section for determining an evaluation period during which it is ensured that interference electromagnetic waves are generated at least once, on the basis of the electromagnetic wave generation rates acquired by the acquisition section; and
the evaluating section performs evaluation of the antenna parameter set on the basis of an evaluation result of signal quality of the area the control apparatus is in charge of during the evaluation period.

4. The wireless communication system according to claim 2 wherein the number of the wireless links in the adjoining area from which generation of interference electromagnetic waves has been requested or from which the electromagnetic wave generation rates have been acquired is applied as the degree of reliability of the evaluation result of the signal quality of the area the control apparatus is in charge of.

5. The wireless communication system according to claim 1, wherein the generation of interference electromagnetic waves from the at least one wireless link arranged in the adjoining area is ensured by an optimization process being executed in the adjoining area, and the evaluating section evaluates the antenna parameter set on the basis of the evaluation result of the signal quality of the area the control apparatus is in charge of, in a state that it is ensured that interference electromagnetic waves are generated at least once.

6. The wireless communication system according to claim 2, wherein
a wireless transmitter constituting at least one wireless link in the area the control apparatus is in charge of transmits a signal quality evaluation packet as a signal that is separatable from a data signal on a side receiving interference, to a wireless receiver constituting the wireless link;
a wireless receiver constituting at least one wireless link in the adjoining area adjoining the area the control apparatus is in charge of is provided with a circuit for evaluating interference electromagnetic waves by the signal quality evaluation packet separately from a circuit for processing a data signal packet and provides an evaluation result about the interference electromagnetic waves to the control apparatus of the area the control apparatus is in charge of; and
the evaluating section includes the provided evaluation result about the interference electromagnetic waves into the evaluation result of the signal quality of the area the control apparatus is in charge of.

7. The wireless communication system according to claim 2, wherein each of the multiple wireless links in the area the control apparatus is in charge of includes multiple evaluation functions having different detectabilities depending on signal quality, and the evaluating section uses an evaluation result of signal quality of a wireless link based on, the multiple evaluation functions, an evaluation function corresponding to signal quality.

8. The wireless communication system according to claim 2, wherein
the control apparatus comprises a collection section for collecting a communication quality evaluation result for each of the wireless links in the area the control apparatus is in charge of; and
the evaluating section performs evaluation of the antenna parameter set set by the setting section, on the basis of the communication quality evaluation result for each of the wireless links collected by the collection section, and updates an antenna parameter set set by the setting section as the latest optimal antenna parameter set if the evaluation is higher than evaluation of the optimal antenna parameter set at the present time point.

9. The wireless communication system according to claim 1, further comprising at least one other control apparatuses in charge of optimizing respective beam configurations of areas other than the area the control apparatus is in charge of, and multiple other wireless links arranged in each of the areas the at least one other control apparatuses are in charge of; wherein
by each of the control apparatus and the at least one other control apparatuses independently repeating setting of the antenna parameter set and evaluation of the antenna parameter set and independently optimizing the beam configuration of the area each control apparatus is in charge of, a beam configuration of the whole space is optimized.

10. An optimization method executed by a control apparatus in charge of optimizing a beam configuration of an area that is configured by dividing a wireless communication network and that includes multiple wireless links each of which is independently communicable, the method comprising:
setting an antenna parameter set for the multiple wireless links in the area the control apparatus is in charge of, in accordance with a search algorithm; and
evaluating the antenna parameter set by the setting step, on the basis of radiation of electromagnetic waves in each of the multiple wireless links in the area the control apparatus is in charge of, in a state that interference electromagnetic waves from at least one wireless links arranged in an adjoining area adjoining the area the control apparatus is in charge of are generated.

11. The optimization method according to claim 10, further comprising:
requesting the at least one wireless link arranged in the adjoining area to generate electromagnetic waves so that a specified electromagnetic wave generation rate is satisfied; and
determining an evaluation period during which it is ensured that interference electromagnetic waves are generated at least once, on the basis of the specified electromagnetic wave generation rate requested by the request step, wherein the evaluation step comprises a step of performing evaluation of the antenna parameter set on the basis of an evaluation result of signal quality of the area the control apparatus is in charge of during the evaluation period.

12. The optimization method according to claim 10, further comprising:
acquiring electromagnetic wave generation rates in the at least one wireless links arranged in the adjoining area; and
determining an evaluation period during which it is ensured that interference electromagnetic waves are generated at least once, on the basis of the electromagnetic wave generation rates acquired by the acquisition step, wherein the evaluation step comprises a step of performing evaluation of the antenna parameter set on the basis of an evaluation result of signal quality of the area the control apparatus is in charge of during the evaluation period.

13. The wireless communication system according to claim 1, wherein the control apparatus further comprises multiple evaluation function circuits each of which has different detectability according to signal quality, the evaluation function circuits being for evaluating signal quality of a wireless link corresponding to signal quality.

14. The wireless communication system according to claim 13, wherein the control apparatus further comprises:
a data signal processing circuit for processing a data signal packet;
an evaluation circuit for evaluating interference electromagnetic waves by a signal quality evaluation packet transmitted by a wireless transmitter constituting at least one wireless link in an adjoining area adjoining the area the control apparatus is in charge of, the evaluation circuit being provided separately from the data signal processing circuit; and
a transmission section for transmitting an evaluation result about the interference electromagnetic waves to a control apparatus in charge of the adjoining area adjoining the area the control apparatus is in charge of.

15. A non-transitory computer readable storage medium tangibly embodying a computer readable program code having computer readable instructions which, when implemented, cause a computer device to carry out the steps of a method for optimizing a beam configuration of an area that is configured by dividing a wireless communication network and that includes multiple wireless links each of which is independently communicable, the method comprising:
setting an antenna parameter set for the multiple wireless links in the area the control apparatus is in charge of, in accordance with a search algorithm; and
evaluating the antenna parameter set by the setting section, on the basis of radiation of electromagnetic waves in each of the multiple wireless links in the area the control apparatus is in charge of, in a state that interference electromagnetic waves from at least one wireless links arranged in an adjoining area adjoining the area the control apparatus is in charge of are generated.

16. The computer readable storage medium according to claim 15, the method further comprising:
requesting the at least one wireless link arranged in the adjoining area to generate electromagnetic waves so that a specified electromagnetic wave generation rate is satisfied; and
determining an evaluation period during which it is ensured that interference electromagnetic waves are generated at least once, on the basis of the specified electromagnetic wave generation rate requested by the request step, wherein the evaluation step comprises a step of performing evaluation of the antenna parameter set on the basis of an evaluation result of signal quality of the area the control apparatus is in charge of during the evaluation period.

17. The computer readable storage medium according to claim 15, the method further comprising:
acquiring electromagnetic wave generation rates in the at least one wireless links arranged in the adjoining area; and
determining an evaluation period during which it is ensured that interference electromagnetic waves are generated at least once, on the basis of the electromagnetic wave generation rates acquired by the acquisition step, wherein the evaluation step comprises a step of performing evaluation of the antenna parameter set on the basis of an evaluation result of signal quality of the area the control apparatus is in charge of during the evaluation period.
